(19) United States
(12) Patent Application Publication
(10) Pub. No.: US 2026/0021003 A1
(43) Pub. Date: Jan. 22, 2026

(54) PULLEY ATTACHMENT DEVICE PROVIDING PASSIVE RANGE OF MOTION FOR UPPER EXTREMITY IN PHYSICAL THERAPY

(71) Applicant: ROM SOLUTIONS, LLC, Gadsden, AL (US)

(72) Inventor: Corey M. Henderson, Gadsden, AL (US)

(21) Appl. No.: 19/261,991

(22) Filed: Jul. 7, 2025

Related U.S. Application Data
(60) Provisional application No. 63/672,483, filed on Jul. 17, 2024.

(51) Int. Cl. A61H 1/02

(52) U.S. Cl. CPC A61H 1/0281; A61H 2201/1276; A61H 2201/149; A61H 2201/1638

(57) ABSTRACT

A pulley attachment device for providing controlled passive range of motion (PROM) for shoulder rehabilitation includes an arm support member. The arm support member defines a hollow portion beneath a curved section to accommodate an immobile arm of a patient. The arm support member includes an extending member extending upward from the arm support member. The arm support member includes a handle grip extending downward from a distal end of the extending member. The handle grip provides a grasp for the patient. The arm support member includes straps configured to wrap around the arm support member to secure the immobile arm, and an arm support cable configured to connect to the arm support member or the extending member. The arm support cable provides a connection to a pulley cable of a pulley system to enable controlled movement of the immobile arm.

### CROSS-REFERENCE TO RELATED APPLICATIONS

The present application claims benefit of U.S. Provisional Application No. 63/672,483, filed Jul. 17, 2024; all of which is incorporated herein in its entirety and referenced thereto.

### BACKGROUND OF THE INVENTION

### Field of the Invention

The present invention relates to physical therapy and rehabilitation, and in particular, relates to a pulley attachment device providing controlled passive range of motion (PROM) for shoulder therapy and/or rehabilitation while maintaining proper alignment of the entire upper extremity.

### Description of the Prior Art

Pulleys have been around and utilized in physical therapy for many years. The pulleys are typically used in multiple rehabilitation settings, including an outpatient setting, inpatient rehab setting, home health setting, and even a personal home exercise program. The pulleys are used to improve upper extremity range of motion (ROM). If not used properly, the pulleys can damage the shoulder and may not improve overhead ROM. It is important to educate the patient of the proper usage of pulleys to reduce the chances of using the pulleys incorrectly.

In physical therapy, the pulley acts as an active assisted range of motion (AAROM) device. The pulley may not be suitable for the early phases of a post-surgical shoulder recovery. AAROM indicates a contralateral upper extremity (UE) being pulled by one end of the pulley while the other (involved) UE is moved into an overhead position. Further, passive range of motion (PROM) is achieved when a patient lies supine on a plinth (elevated surface) while a therapist holds the involved UE and moves through available ROM. PROM is beneficial when an individual/patient is unable to actively move a body segment. In the early stages of a rotator cuff repair, active range of motion can cause damage to the recently repaired soft tissue. PROM is when an external force moves the body segment. Continuous passive movement (CPM) machines do provide PROM; however, the patient has minimal control and the CPM machines are expensive treatment options. PROM is preferred as it reduces adhesion formations, maintains flexibility in surrounding soft tissue, improves circulation, reduces pain, and can improve range of motion.

Several pulley systems have been disclosed in the past for use in the rehabilitation of various shoulder conditions. One such example is disclosed in United States Publication No. 20050272570, entitled “Anatomical shoulder pulley system” (“the '570 Publication”). The '570 Publication discloses an anatomical shoulder pulley system for use in the rehabilitation of various shoulder conditions. The device provides a means of converting the linear pull of a rope and pulley system into rotary motion that approximates the arc described by anatomical or physiological motion of the shoulder. The device can be adjusted to provide passive or assisted motion in varied planes of shoulder motion such as forward flexion, external or internal rotation or scapular plane shoulder elevation. A door unit section of the device secures the device to a standard door and provides a base for the device. Another section of the device consists of an arced track and associated components. The arced track may be secured to the door unit in varied degrees of rotation. A rope with a handle on one end is routed over a pulley located at the top of the arced track. The other end of the rope is attached to a track rider that can easily move upward and downward within the arced track. A rope and handle are also attached to the track rider. The user grasps both handles. By pulling down on the free end handle, the handle attached to the arced track moves upward along the track assisting a person to move their shoulder in an arc that approximates anatomical or physiological movement.

Another example is disclosed in a U.S. Pat. No. 7,364,555, entitled “Self-assisted shoulder passive range of motion apparatus” (“the '555 patent”). The '555 patent discloses a self-assisted shoulder passive range of motion (SA-PROM) apparatus. The apparatus includes a forearm support adapted to receive the forearm of the affected arm, a double pulley assembly, a single pulley connectable to an elevated support such as an upper door edge, and a main support rope, one end of which is attached to the double pulley, the other end having an enlarged handle. A central portion of the main support rope is engageable over the single pulley. A secondary rope arrangement which is preferably formed of a single length of rope, is attached to each of a plurality of holes formed through said forearm support in proximity to each end and each side margin of the forearm support and arranged over the secondary pulleys to self-regulate pitch and roll movement of the forearm support. The affected arm may be passively raised and lowered through a range of motion by pulling on the handle with the unaffected arm.

Another example is disclosed in a United States Publication No. 20130317395, entitled “Therapy apparatus to restore range of motion of limbs” (“the '395 Publication”). The '395 Publication discloses a therapy apparatus to restore range of motion to joints and limbs. The apparatus is useful for elbow joints and includes a beam on which the elbow joint rests. A tension cord extends through and beyond the length of the elongated hollow beam with a handle at the distal end of the tension cord to be grasped by the user. The proximal end of the cord is pulled by the user's other hand to rotate the elbow. A ratchet clamp forming a part of the beam retains the tension on the elbow. Since it is a ratchet clamp, the cord may be freely pulled in the proximal direction to impart more tension to the elbow, but to release the tension, the ratchet clamp must be disengaged manually. The beam has segments that are telescopically extendable and retractable to accommodate limbs of different lengths and for portability and storage.

Yet another example is disclosed in a U.S. Pat. No. 11,666,501, entitled “Devices and methods for assisting pronation and/or supination” (“the '501 patent”). The '501 patent discloses devices that manipulate a hand of a user to provide pronation or supination assistance. Embodiments include an anchor; a hand engagement member operatively attached to the anchor and configured to receive and engage the hand of the user; a force applicator having a member portion and an anchor portion opposite the member portion, the force applicator attached to the hand engagement member proximate its member portion and attached to the anchor proximate its anchor portion; and a force application mechanism attached to the anchor and configured to cause a force to be applied to the force applicator causing the hand engagement member to manipulate the hand of the user to provide pronation or supination assistance. In some embodiments, the force application mechanism includes a non-incremental rotary mechanism. In some embodiments, a flexible tethering member attaches the anchor to the hand engagement member.

Although the above discussed disclosures are useful, they have few problems. For example, PROM poses certain challenges, as the patient has to trust and relax in order to have smooth rolling of the glenohumeral (GH) joint in the shoulder. The patient tends to be guarded and resist the passive movement. Further, several patients do not prefer manual or PROM performed to their shoulder.

Therefore, there is a need in the art to provide a pulley attachment device that provides controlled passive range of motion (PROM) for shoulder rehabilitation.

### SUMMARY OF THE INVENTION

It is an object of the present invention to provide a pulley attachment device offering controlled passive range of motion (PROM) for shoulder rehabilitation.

It is another object of the present invention to provide a pulley attachment device that prevents incorrect pulley performance by properly aligning the distal joints and minimizing impingement.

It is another object of the present invention to provide a pulley attachment device that eliminates glenohumeral (GH) internal and external rotation by immobilizing the wrist and forearm, and maintaining the thumb pointing superiorly, thereby preventing GH rotations.

It is another object of the present invention to provide a pulley attachment device that addresses the issue of patients choosing the path of least resistance, such as performing the pulley with the elbow flexed.

In order to achieve one or more objects, the present invention provides a pulley attachment device offering controlled passive range of motion (PROM) for shoulder rehabilitation. The pulley attachment device includes an arm support member having a 20 degree-angle. The arm support member defines a hollow portion beneath a curved section to accommodate an immobile arm of a patient. The arm support member includes an extending member extending upward from the arm support member. The arm support member includes a handle grip extending downward from a distal end of the extending member. The handle grip provides a grasp for the patient. The arm support member includes straps configured to wrap around the arm support member to secure the immobile arm.

In one aspect of the present invention, the arm support member includes an arm support cable configured to connect to the arm support member. Here, the arm support member includes a U-shaped member and a support rod comprising an opening at the top of the curved section. The arm support cable draws through the opening and the U-shaped member to connect the arm support member to a pulley cable. The arm support cable provides a connection to a pulley cable of the pulley system to enable controlled movement of the immobile arm.

In another aspect of the present invention, the arm support member includes an arm support cable configured to connect to the extending member. Here, the arm support cable draws through the handle grip and rests against the extending member for connection to the pulley system. The arm support cable provides a connection to the pulley cable of the pulley system to enable controlled movement of the immobile arm.

The pulley attachment device supports the arm fully, avoiding the distal muscles to contract to perform the pulley. This allows the patient to relax and perform pulleys with the involved upper extremity. Here, the patient operates the pulley system with the other hand to make the pulley system to become a passive movement by not having to hold any device, say a handle for example. The pulley attachment device allows the pulley system to be used as a passive movement device allowing the patient to control their physical therapy/rehabilitation while minimizing muscle contraction.

In one advantageous feature of the present invention, the pulley attachment device offers optimal arm positioning for shoulder movement and prevents common pulley exercise/therapy errors.

In another advantageous feature of the present invention, the pulley attachment device requires minimum education and supervision to operate/use. As such, the patient can use the pulley attachment device in an outpatient setting, inpatient rehab, and at home. For example, the pulley attachment device can be used at home as a home exercise device and without the need for a physical therapist to improve shoulder range of motion (ROM).

In another advantageous feature of the present invention, the pulley attachment device allows the patient to relax while performing physical therapy without additional guarding, such as holding a handle and contracting their muscles. The pulley attachment device is used while sitting.

These and other objects of the present invention will be apparent from review of the following specification and the accompanying drawings.

### BRIEF DESCRIPTION OF THE DRAWINGS

FIG. 1 is an environment in which a pulley attachment device implements, in accordance with one exemplary embodiment of the present invention.

FIG. 2 illustrates a perspective view of the pulley attachment device, in accordance with one embodiment of the present invention.

FIG. 3 illustrates a front view of the pulley attachment device without straps and an arm support cable, in accordance with one embodiment of the present invention.

FIG. 4 is an environment in which a pulley attachment device implements, in accordance with another exemplary embodiment of the present invention.

### DETAILED DESCRIPTION OF THE PREFERRED EMBODIMENT

The detailed description set forth below in connection with the appended drawings is intended as a description of exemplary embodiments in which the presently disclosed invention may be practiced. The term “exemplary” used throughout this description means “serving as an example, instance, or illustration,” and should not necessarily be construed as preferred or advantageous over other embodiments. The detailed description includes specific details for providing a thorough understanding of the presently disclosed pulley attachment device. However, it will be apparent to those skilled in the art that the presently disclosed invention may be practiced without these specific details. In some instances, well-known structures and devices are shown in functional or conceptual diagram form in order to avoid obscuring the concepts of the presently disclosed pulley attachment device.

In the present specification, an embodiment showing a singular component should not be considered limiting. Rather, the invention preferably encompasses other embodiments including a plurality of the same component, and vice-versa, unless explicitly stated otherwise herein. Moreover, the applicant does not intend for any term in the specification to be ascribed an uncommon or special meaning unless explicitly set forth as such. Further, the present invention encompasses present and future known equivalents to the known components referred to herein by way of illustration.

Although the present invention describes a pulley attachment device, it is to be further understood that numerous changes may arise in the details of the embodiments of the pulley attachment device. It is contemplated that all such changes and additional embodiments are within the spirit and true scope of this invention.

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the invention and are not intended to limit the scope of the invention.

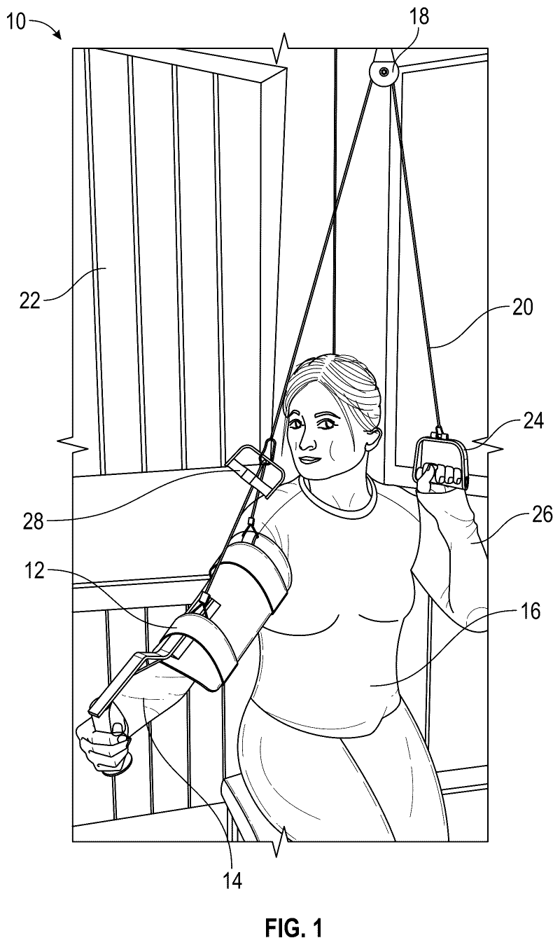

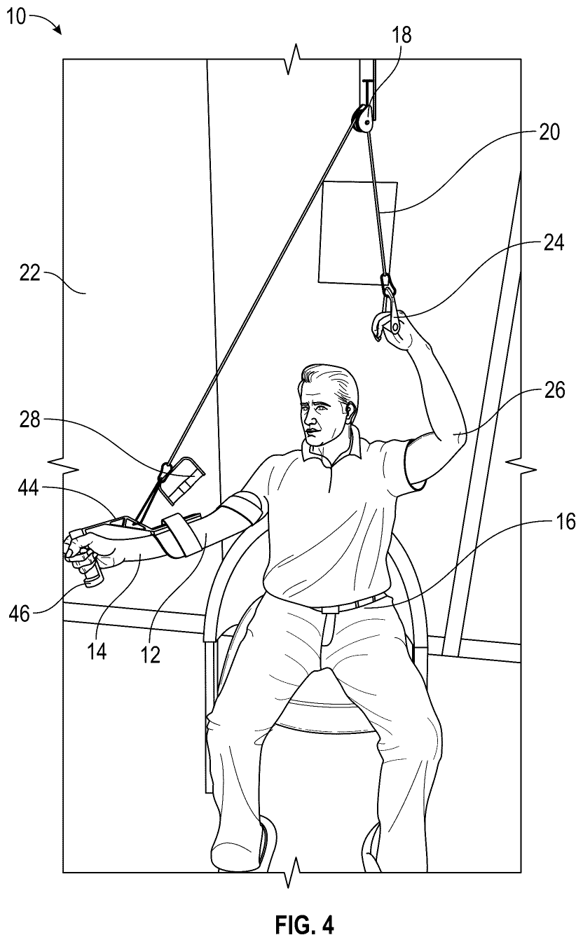

Various features and embodiments of a pulley attachment device are explained in conjunction with the description of FIGUREs (FIGS. 1-4.

FIG. 1 shows an environment 10 in which a pulley attachment device 12 is implemented, in accordance with one embodiment of the present invention. Pulley attachment device 12 receives the immobile arm/hand 14 of patient 16. Pulley attachment device 12 is connected to a pulley system 18 via a pulley cable 20. In one example, pulley system 18 connects to a pole or stand or structure 22. Patient 16 holds a first handle 24 provided at one distal end of pulley cable 20 with his/her other hand 26. In some cases, pulley cable 20 includes a second handle 28 at a distal end that connects to pulley attachment device 12. In the present invention, patient 16 holds first handle 24 to move immobile arm 14 via pulley attachment device 12.

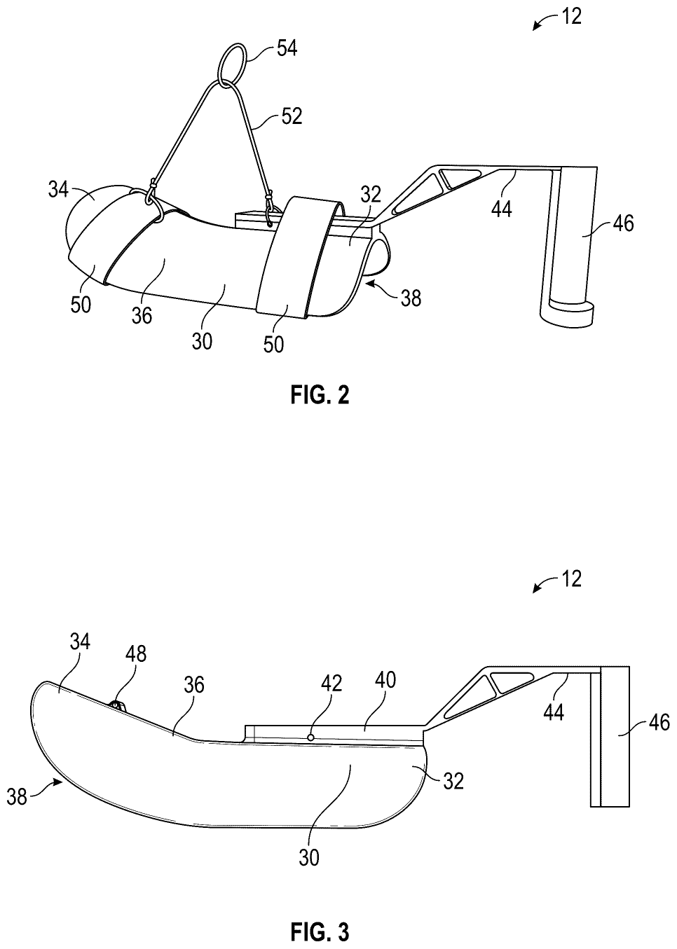

FIG. 2 shows a perspective view of pulley attachment device 12, in accordance with one embodiment of the present invention. Pulley attachment device 12 includes an arm support member 30. In one example, arm support member 30 comes in an arced shape. Arm support member 30 is designed for use on both left and right arms. In one example, arm support member 30 is designed to fit over and conform to the shape of the top portion of immobile arm 14 (i.e., shoulder and elbow). In another example, arm support member 30 is designed to fit over and conform to the shape of the bottom portion of immobile arm 14 (i.e., forearm and bicep portion). In one implementation, arm support member 30 is made of black PLA or polylactic acid (3D printed).

Arm support member 30 includes a first end 32, and a second end 34. Arm support member 30 includes a curved section 36 that forms a hollow portion 38 beneath. In some cases, arm support member 30 rises at second end 34 to engage an elbow or bicep of patient 16. Further, first end 32 has a straight configuration to engage a forearm of patient 16. In some cases, second end 34 angles upward at 20 degrees with respect to the straight portion of first end 32. Here, the straight portion of arm support member 30 extends nearly half the length of arm support member 30. The angled second end 34 angle allows the elbow to remain fixed/immobilized at approximately 20 degrees of flexion.

In one embodiment, arm support member 30 includes a support rod 40. Support rod 40 connects at the top of first end 32 of arm support member 30. In one example, support rod 40 defines a first opening 42 for receiving one end of arm support cable 52. Further, arm support member 30 includes an extending member 44. Extending member 44 is made of material such as metal, hard plastic, or any other suitable material. Extending member 44 may have straight, curved, step-like, or angled configuration, or a combination thereof. Preferably, extending member 44 extends upwards from first end 32 of arm support member 30, as shown in FIG. 3, for example. It should be understood that FIG. 3 shows arm support member 30 without straps 50 and pulley cable 52. Extending member 44 connects to support rod 30 or curved section 36. In some cases, the length of extending member 44 is adjustable such that patient 16 can adjust the placement of arm support member 30 over their immobile arm 14. Extending member 44 includes a handle grip 46. Handle grip 46 extends down from a distal end of extending member 44. In the present embodiment, handle grip 46 may be encased in a soft material to provide easy grasp for patient 16.

In addition, arm support member 30 includes a U-shaped member 48. U-shaped member 48 is positioned in proximity to second end 34 at the top of curved section 36, as shown in FIG. 3. By positioning both support rod 40 and U-shaped member 48 at the top of curved section 36, hollow portion 38 remains clear, allowing it to interface with patient's immobile arm 14 without interference.

Further, pulley attachment device 12 includes one or more straps 50. Each strap 50 wraps around arm support member 30 to secure immobile arm 14, as shown in FIG. 1, for example. In one example, two straps 50 are provided around arm support member 30. One strap 50 positions near first end 32, and another strap 50 positions near second end 34. Straps 50 may be made of a material that provides comfort and the necessary support for securing immobile arm 14 to arm support member 30. In one example, strap 50 includes a hook and loop. In another example, strap 50 may include a hook at one end and a groove at the other end to couple the distal ends. In another example, strap 50 may include male and female members to connect as a buckle system known in the art. It should be understood that strap 50 may come in a variety of configurations to support arm support member 30 around patient's immobile arm 14.

In addition, pulley attachment device 12 includes an arm support cable or paracord 52. In one example, arm support cable 52 draws through a ring 54 and connects to first opening 42 at first end 32 and U-shaped member 48 at second end 34, as shown in FIG. 2. Here, first opening 42 and U-shaped member 48 act as attachment members for connecting arm support cable 52 to arm support member 30.

Pulley attachment device 12 can be connected to pulley system 18 via pulley cable 20 in different ways. FIG. 1 shows an exemplary way of using pulley attachment device 12 for home exercise. Here, patient 16 places arm support member 30 over immobile arm 14 and holds handle grip 46. Subsequently, a caregiver or patient 16 may tighten straps 50 to secure arm support member 30 around patient's immobile arm 14. Subsequently, patient 16 may connect arm support cable 52 to second handle 28 via ring 54. As specified above, pulley cable 20 includes first handle 24, which patient 16 holds with his/her other hand 26. After connecting, patient 16 may pull the other hand 26 to raise or lower immobile arm 14 with support from pulley cable 20 and arm support member 30.

FIG. 3 shows another exemplary way of using pulley attachment device 12 for home exercise. Here, arm support cable 52 draws through handle grip 46 and extending member 44, and rests against extending member 44. Further, arm support cable 52 is connected to pulley cable 20 via second handle 28 and/or ring 54. This connection avoids the use of U-shaped member 48 and/or first opening 42 for connecting arm support cable 52 to arm support member 30. After connecting pulley cable 20 to arm support cable 52, patient 16 may pull the other hand 26 to raise or lower immobile arm 14 with support from pulley cable 20 and arm support member 30.

The presently disclosed pulley attachment device 12 can be used for home exercise without the need for a physical therapist to improve shoulder range of motion (ROM). In accordance with the present invention, pulley attachment device 12 is designed to place the involved upper extremity in scaption of the GH joint. As such, pulley attachment device 12 can be referred to as a “A-flex upper extremity attachment device 12”. Here, A-flex indicates ‘without flexion,’ referring to preventing elbow flexion to achieve true range of motion at the GH joint. Overhead ROM is preferred for achieving functional shoulder movements. The shoulder is a ball and socket type synovial joint which is highly moveable. A capsule surrounds the GH joint. Adhesive capsulitis or frozen shoulder is when the capsule is tight and requires an outside force to improve or restore ROM. Pulley attachment device 12 is designed to place the involved upper extremity in scaption of the GH joint, approximately 20 degrees elbow flexion, neutral pronation and supination, and no wrist flexion or extension. This allows for optimal movement of the upper extremity. By stabilizing the entire immobile arm 14, pulley attachment device 12 functions as a passive movement device, entirely controlled by patient/user 16. As a result, pulley attachment device 12 allows patient 16 to relax, reduces guarded movement patterns, and provides control over their upper extremity. Patient 16 may sit in a chair and use their other hand to pull or release pulley cable 20 via pulley system 18, as shown in FIG. 1 or FIG. 3. Pulley attachment device 12 can be used in an outpatient setting, inpatient rehab, and at home. Individuals with orthopedic injuries or neurological pathology, such as hemiparesis/hemiplegia due to peripheral or central nervous system lesions, are one example of those who would potentially benefit from the pulley attachment.

Typically, patients are educated to operate the pulleys by instructions such as “keep your elbow straight” and how to “keep your thumb pointing up”. The presently disclosed pulley attachment device 12 is easy to put on immobile arm 14 and connect to pulley system 18 via pulley cable 20. As a result, pulley attachment device 12 requires less education, thereby reducing the chances of errors in performing the pulley exercise incorrectly. This allows for optimal ROM improvements, less guarding, less pain, and improved outcomes.

The presently disclosed pulley attachment device 12 prevents patient 16 from performing the pulley incorrectly by correctly placing the distal joints in proper alignment and minimizing impingement. In a busy outpatient clinic treating numerous patients, it is difficult to constantly monitor each patient performing the pulley exercises. Especially when patients go home, they may choose the path of least resistance and perform the pulley with the elbow flexed, which prevents the proper roll and glide of the humerus on the glenoid fossa and thus does not increase overhead range of motion. The minimal education required to operate pulley attachment device 12 lessens the chances of errors in performing the pulley exercise incorrectly.

In addition, when compared with prior art e.g., United States Publication No. 20050272570, entitled “Anatomical shoulder pulley system” (“the '570 Publication”), the presently disclosed pulley attachment device 12 offers significant advantages. The '570 Publication's simple pulley disadvantageously places the upper extremity in internal rotation of the GH joint. In contrast, pulley attachment device 12 eliminates GH internal and external rotation by immobilizing the wrist and forearm, thereby preventing unwanted GH rotations. With pulley attachment device 12, pulley system 18 facilitates passive movement because the patient does not have to hold a handle. In the '570 Publication, when the patient grasps a handle, they must contract intrinsic and extrinsic muscles in the arm, which means it does not provide true passive movement of the upper extremity. In the present invention, pulley attachment device 12 fully supports patient 16's immobile arm 14 via straps 50. As a result, the distal muscles do not need to contract to perform the pulley exercise. This allows patient 16 to relax and perform the pulley effortlessly with the involved upper extremity.

The presently disclosed pulley attachment device provides several advantages over prior art. The pulley attachment device offers proper alignment and stabilization of the upper extremity for shoulder movement, including controlled scaption, elbow flexion, and neutral forearm rotation. The design of pulley attachment device immobilizes the wrist and forearm, and eliminates unwanted shoulder rotations. This reduces the risk of impingement and enhances the range of motion (ROM). The pulley attachment device allows the pulley system to be used as a passive movement device, enabling patients to control their physical therapy/rehabilitation while minimizing muscle contraction.

A person skilled in the art appreciates that the pulley attachment device can come in a variety of shapes and sizes depending on the need and comfort of the user. Further, many changes in the design and placement of components may take place without deviating from the scope of the presently disclosed pulley attachment device.

In the above description, numerous specific details are set forth such as examples of some embodiments, specific components, devices, methods, in order to provide a thorough understanding of embodiments of the present invention. It will be apparent to a person of ordinary skill in the art that these specific details need not be employed, and should not be construed to limit the scope of the invention.

In the development of any actual implementation, numerous implementation-specific decisions must be made to achieve the developer's specific goals, such as compliance with system-related and business-related constraints. Such a development effort might be complex and time-consuming, but may nevertheless be a routine undertaking of design, fabrication, and manufacture for those of ordinary skill. Hence as various changes could be made in the above constructions without departing from the scope of the invention, it is intended that all matter contained in the above description or shown in the accompanying drawings shall be interpreted as illustrative and not in a limiting sense.

The foregoing description of embodiments is provided to enable any person skilled in the art to make and use the invention. Various modifications to these embodiments will be readily apparent to those skilled in the art, and the novel principles and invention disclosed herein may be applied to other embodiments without the use of the innovative faculty. It is contemplated that additional embodiments are within the spirit and true scope of the disclosed invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A pulley attachment device, comprising:
an arm support member defining a hollow portion beneath a curved section to accommodate an immobile arm of a patient;
an extending member extending upward from said arm support member;
a handle grip extending downward from a distal end of said extending member, wherein said handle grip provides a grasp for said patient;
straps configured to wrap around said arm support member to secure said immobile arm; and
an arm support cable configured to connect to said arm support member or said extending member,
wherein said arm support cable provides a connection to a pulley cable of a pulley system to enable controlled movement of said immobile arm.

2. The pulley attachment device of claim 1, wherein said arm support member has an arced configuration.

3. The pulley attachment device of claim 1, wherein a length of said extending member is adjustable to allow adjustment of a placement of said arm support member over said immobile arm.

4. The pulley attachment device of claim 1, wherein said arm support cable comprises a ring, and wherein said ring connects to said pulley cable.

5. The pulley attachment device of claim 1, wherein said arm support member comprises a U-shaped member and a support rod at the top of said curved section, wherein said support rod comprises an opening.

6. The pulley attachment device of claim 5, wherein said arm support cable draws through said opening and said U-shaped member to connect said arm support member to said pulley cable.

7. The pulley attachment device of claim 1, wherein said arm support member comprises a first end and a second end, and wherein said second end angles upward relative to said first end to support the elbow at a predetermined flexion angle.

8. The pulley attachment device of claim 1, wherein said arm support member comprises a first end and a second end, and wherein said second end angles upward at approximately 20 degrees relative to a straight portion of said first end.

9. The pulley attachment device of claim 1, wherein said extending member has one of a straight, curved, step-like, and angled configuration.

10. The pulley attachment device of claim 1, wherein said arm support cable draws through said handle grip and rests against said extending member for connection to said pulley cable.

11. A pulley attachment device, comprising:
an arm support member defining a hollow portion beneath a curved section to accommodate an immobile arm of a patient, wherein said arm support member comprises a U-shaped member and a support rod at the top of said curved section, and wherein said support rod comprises an opening;
an extending member extending upward from said support rod of said arm support member;
a handle grip extending downward from a distal end of said extending member, wherein said handle grip provides a grasp for said patient;
straps configured to wrap around said arm support member to secure said immobile arm; and
an arm support cable configured to draw through said opening of said support rod and said U-shaped member,
wherein said arm support cable provides a connection to a pulley cable of a pulley system to enable controlled movement of said immobile arm.

12. The pulley attachment device of claim 11, wherein said arm support member has an arced configuration.

13. The pulley attachment device of claim 11, wherein a length of said extending member is adjustable to allow adjustment of a placement of said arm support member over said immobile arm.

14. The pulley attachment device of claim 11, wherein said arm support cable comprises a ring, and wherein said ring connects to said pulley cable.

15. The pulley attachment device of claim 11, wherein said arm support member comprises a first end and a second end, and wherein said second end angles upward relative to said first end to support the elbow at a predetermined flexion angle.

16. The pulley attachment device of claim 11, wherein said arm support member comprises a first end and a second end, and wherein said second end angles upward at approximately 20 degrees relative to a straight portion of said first end.

17. The pulley attachment device of claim 11, wherein said arm support member comprises a first end and a second end, and wherein said extending member extends upward from said first end of said arm support member.

18. The pulley attachment device of claim 11, wherein said extending member has one of a straight, curved, step-like, and angled configuration.

19. The pulley attachment device of claim 11, wherein said handle grip is encased in a soft material to provide easy grasp for said patient.

20. A method of providing a pulley attachment device for passive movement of an immobile arm of a patient, said method comprising the steps of:
providing an arm support member defining a hollow portion beneath a curved section to accommodate an immobile arm of a patient;
providing an extending member extending upward from said arm support member;
providing a handle grip extending downward from a distal end of said extending member, said handle grip providing a grasp for said patient;
providing straps to wrap around said arm support member to secure said immobile arm;
providing an arm support cable to connect to said arm support member or said extending member; and
providing a connection to a pulley cable of a pulley system with said arm support cable to enable controlled movement of said immobile arm.
